(19) United States
(12) Patent Application Publication
(10) Pub. No.: US 2011/0002373 A1
(43) Pub. Date: Jan. 6, 2011

(54) APPARATUS FOR PERFORMING BEAM TRACKING PROCESS AND METHOD THEREOF

(75) Inventor: Beom Jin Jeon, Seoul (KR)

Correspondence Address: BIRCH STEWART KOLASCH & BIRCH, PO BOX 747, FALLS CHURCH, VA, 22040-0747, US

(73) Assignee: LG ELECTRONICS INC., SEOUL (KR)

(21) Appl. No.: 12/921,891

(22) PCT Filed: Mar. 11, 2009
(86) PCT No.: PCT/KR09/01208

§ 371 Date: Sep. 10, 2010

(30) Foreign Application Priority Data
Mar. 11, 2008 (US) 61/035719
Apr. 2, 2008 (US) 61/041601
Jun. 11, 2008 (KR) 10-2008-0054643
Jun. 16, 2008 (KR) 10-2008-0056317
Jun. 26, 2008 (KR) 10-2008-0060975

(51) Int. Cl. H04B 17/00

(52) U.S. Cl. 375/228

(57) ABSTRACT

A method for performing beam tracking in a wireless communication network is provided. In the method, a transmitter station emits beam patterns including respective beam pattern indices to receiver stations and receives a feedback index indicating one of the beam patterns from each receiver station during a predetermined channel time after the emission of beam patterns is completed. A beam pattern feedback is processed using a simple code, thereby minimizing the amount of information and hardware required for beam search and tracking. In addition, in uni-directional beam tracking, it is possible to perform tracking on a number of beam links at once and a sub-channel that can be used for beam tracking and search is allocated to each station to allow a number of stations to simultaneously perform beam search, thereby reducing the amount of used channel time.

### TECHNICAL FIELD

The present invention relates to a method and apparatus for allocating beam search times required for wireless transmission having high directionality to perform efficient beam search and tracking.

### BACKGROUND ART

In a Multiple-Input Multiple-Output (MIMO) communication system, a transmitter station uses multiple transmit antennas and a receiver station uses multiple receive antennas for data communication. A single MIMO channel created by the antennas can be decomposed into independent channels. Each of the independent channels is a sub-channel (or transport channel) in the space domain of the MIMO channel and occupies one scope. The MIMO system can exhibit improved performance (for example, improved transmission capacity) when additional scopes created by multiple antennas are used.

The MIMO system is divided into two types, namely, open-loop and closed-loop. In the open-loop system, space-time coding technologies are generally implemented in the MIMO transmitter station to achieve resistance to channel fading since the MIMO transmitter station has no prior knowledge of channel status. On the other hand, in the closed-loop system, the receiver station may feed Channel Status Information (CSI) back to the transmitter station. Then, the transmitter station performs a pre-processing operation based on the CSI, thereby achieving simple receiver design and better performance. These technologies are referred to as ‘beamforming technologies’, in which a better performance gain is provided in a direction toward a desired receiver station while transmission power in other directions is suppressed.

The probability that problems such as loss will occur increases as the number of wireless communication stations that participate in the wireless network increases. Collision between stations requires retransmission that has significant negative effects on transfer rate (i.e., throughput) of the wireless network. Particularly, when higher Quality of Service (QoS) is required as for Audio/Video (AV) data, it is very important to reduce the number of retransmissions to secure a greater available bandwidth.

Taking into consideration that the need to wirelessly communicate high-quality video such as Digital Video Disk (DVD) video or High Definition Television (HDTV) video between a variety of home stations is on the rise, a technical standard for constantly transmitting and receiving high-quality video requiring a wide bandwidth is required.

A technical standard for transmitting a large amount of data in a wireless home network is under discussion in an IEEE 802.15.3c task group. This technical standard, which is referred to as ‘millimeter Wave (mmWave)’, uses radio waves having wavelengths of millimeters (specifically, radio waves having frequencies of 30 GHz to 300 GHz) for a large amount of data transmission. These frequency bands have been generally used as unlicensed bands for limited purposes such as communication providers, radio astronomy, or vehicle-collision avoidance.

IEEE 802.11b or IEEE 802.11g uses a carrier frequency of 2.4 GHz and a channel bandwidth of about 20 MHz. IEEE 802.11a or IEEE 802.11n uses a carrier frequency of 5 GHz and a channel bandwidth of about 20 MHz. On the other hand, mmWave uses a carrier frequency of 60 GHz and a channel bandwidth of about 0.5 to 2.5 GHz. Thus, the carrier frequency and the channel bandwidth of mmWave are much greater than those of the IEEE 802.11 series.

If high-frequency signals having wavelengths of millimeters are used as described above, it is possible to achieve a very high transfer rate of Gbps and to reduce antenna size below 1.5 mm, thereby realizing a single chip including antennas. It is also possible to reduce interference between stations since attenuation ratio is very high in the air.

However, if mmWave is used, it is difficult to perform omni-directional transmission of signals since the beam range is reduced due to such a high attenuation ratio. To overcome this problem, beams should be sharpened. However, if beams are sharpened, beams are transmitted only to a local area.

mmWave also has a problem in that it is difficult to perform communication in Non-Line-of-Sight environments since the beam range is short due to the high attenuation ratio and the straightness of signals is high. mmWave uses an array antenna having a high gain to overcome the former problem and uses beam steering to overcome the latter problem.

In the case where transmission loss is high and transmission power is limited, to secure a desired transmission distance, it is necessary to obtain a desired antenna gain using antenna technologies. This requires a method for establishing and maintaining a beam link.

A beam link is generally created as a transmitting end emits beams in all directions and a receiving end feeds information indicating an available beam among the beams back to the transmitting end. After the link is created, beam search is repeated in order to reflect channel changes. This procedure is referred to as ‘tracking’. A channel time is used for such tracking and search. However, if the number of beam links in a given network is increased, the time required to perform beam search and tracking is increased. Accordingly, there is a need to provide a method for performing such a procedure as simply and efficiently as possible.

### DISCLOSURE OF INVENTION

### Technical Problem

An object of the present invention provides a beam tracking method which minimizes the amount of information and hardware required for beam search and tracking and which adaptively schedules channel times to reduce the amount of used channel time.

### Technical Solution

To achieve these and other advantages and in accordance with the purpose of the present invention, as embodied and broadly described, an apparatus for controlling beam tracking process, the apparatus includes a communication module configured to transmit data to at least one of external station and coordinator, and configured to receive data from at least one of external station and coordinator, and a controller configured to control the communication module to transmit first beam patterns to at least one station, each of the first beam patterns being identified by beam pattern index, and configured to control the communication module to receive a feedback index from the at least one station during a predetermined duration, the feedback index indicating one beam pattern selected by the at least one station among the first beam patterns.

Preferably, the first status information includes mobility information, link status information and antenna angle information about the receiver station.

Preferably, the second status information includes quality of service (QoS) information, mobility information, channel status information and antenna angle information about the transmitter station.

To further achieve these and other advantages and in accordance with the purpose of the present invention, an apparatus for performing beam tracking process, the apparatus includes a communication module configured to transmit data to at least one of external station and coordinator, and configured to receive data from at least one of external station and coordinator, and a controller configured to control the communication module to transmit a request message requesting to allocate a channel time for performing the beam tracking process, configured to control the communication module to receive channel allocating information corresponding to the request message, and configured to control to perform the beam tracking process using a beam pattern index based on the channel allocating information.

Preferably, the channel allocating information includes starting information, duration information and channel number information.

In this case, the starting information indicates starting point of an allocated channel time, and the duration information indicates duration of the allocated channel time, and the channel number information indicates identification identifying sub-channels, the sub-channels being divided by a frequency band during the allocated channel time.

To further achieve these and other advantages and in accordance with the purpose of the present invention, an apparatus for controlling beam tracking process, the apparatus includes a communication module configured to transmit data to at least one of external station and coordinator, and configured to receive data from at least one of external station and coordinator, and a controller configured to control the communication module to transmit first beam patterns to at least one station, each of the first beam patterns being identified by beam pattern index, and configured to control the communication module to receive a feedback index from the at least one station during a predetermined duration, the feedback index indicating one beam pattern selected by the at least one station among the first beam patterns.

Preferably, the beam pattern index and the feedback index are generated by using a baker code.

Preferably, the predetermined duration includes a plurality of sub channels, the sub channels being divided by a different frequency band at same time, and the feedback index of the at least one station is received via the sub channel.

To further achieve these and other advantages and in accordance with the purpose of the present invention, a method for performing a beam tracking process in a transmitter station, the method includes receiving first status information from a receiver station, the first status information being associated with status of the receiver station, determining a period of the beam tracking process based on second status information and the first status information, the second status information being associated with status of the transmitter station, and performing the beam tracking process every the determined period.

In the case, the period is time interval between current beam tracking process and next beam tracking process.

Preferably, the first status information is received periodically.

Preferably, the first status information includes mobility information, link status information and antenna angle information about the receiver station.

Preferably, the second status information includes quality of service (QoS) information, mobility information, channel status information and antenna angle information about the transmitter station.

Preferably, the determining step further includes if the antenna angle information included in the first and second status information indicates that an antenna angle of at least one of the transmitter station and the receiver station is larger than a predetermined value, the period of the Beam Tracking process is controlled to decrease.

Preferably, the determining step further includes if the QoS information included in the second status information indicates that a quality of service (QoS) of the transmitter station is higher than a predetermined level, the period of the beam tracking process is controlled to decrease.

Preferably, the determining step further includes if the mobility information included in the first and second status information indicates that a mobility of at least one of the transmitter station and the receiver station is higher than a predetermined status, the period of the beam tracking process is controlled to decrease.

Preferably, the determining step further includes if the channel status information in the second status information indicates idle status of the transmitter station, the period of the beam tracking process is controlled to decrease.

Preferably, the antenna angle information included in the first and second status information is determined from a radio layer management element (RLME) being connected to an antenna analog layer.

To further achieve these and other advantages and in accordance with the purpose of the present invention, a method for performing beam tracking process in a station, the method includes transmitting a request message requesting to allocate a channel time for performing the beam tracking process to a coordinator, receiving channel allocating information corresponding to the request message from the coordinator, and performing the beam tracking process using a beam pattern index based on the channel allocating information.

Preferably, the channel allocating information includes starting information, duration information and channel number information.

In this case, the starting information indicates starting point of an allocated channel time, and the duration information indicates duration of the allocated channel time, and the channel number information indicates identification identifying sub-channels, the sub-channels being divided by a frequency band during the allocated channel time.

Preferably, the request message includes at least one of destination information, type information, duration information and period information.

In this case, the destination information indicates a target station for the beam tracking process, and type information indicates direction of the beam tracking process, and the duration information indicates duration for the beam tracking process, and the period information indicates a period of the beam tracking process.

Preferably, the channel allocating information further includes station identification information identifying stations participated in the beam tracking process.

To further achieve these and other advantages and in accordance with the purpose of the present invention, a method for controlling beam tracking process, the method includes transmitting first beam patterns to at least one station, each of the first beam patterns being identified by beam pattern index, and receiving a feedback index from the at least one station during a predetermined duration, the feedback index indicating one beam pattern selected by the at least one station among the first beam patterns.

Preferably, the beam pattern index and the feedback index are generated by using a baker code.

Preferably, the predetermined duration is a channel time allocated by a coordinator, for performing the beam tracking process.

Preferably, the at least one feedback index is received using a Listen-Before-Talk method.

Preferably, the predetermined duration includes a plurality of sub channels, the sub channels being divided by a different frequency band at same time, and the feedback index of the at least one station is received via the sub channel.

To further achieve these and other advantages and in accordance with the purpose of the present invention, a method for controlling beam tracking process, the method includes transmitting first beam patterns to a target station, each of the first beam patterns being identified by beam pattern index, receiving first feedback index and second beam patterns from the target station during a predetermined duration, the first feedback index indicating one beam pattern selected by the target station among the first beam patterns, each of the second beam patterns being identified by beam pattern index, determining one beam pattern among the second beam patterns, and transmitting second feedback index to the target station, the second feedback index indicating the one beam pattern determined by determining step.

To further achieve these and other advantages and in accordance with the purpose of the present invention, a method for performing a beam tracking process in a transmitter station, the method includes receiving first status information from a receiver station, the first status information being associated with status of the receiver station, determining a period of the beam tracking process based on second status information and the first status information, the second status information being associated with status of the transmitter station, transmitting a request message requesting to allocate a channel time for performing the beam tracking process to a coordinator according to the period of the beam tracking process, receiving channel allocating information corresponding to the request message from the coordinator, transmitting beam patterns to at least one receiver station according to the channel allocating information, each of the beam patterns being identified by beam pattern index, and receiving at least one feedback index from the at least one receiver station during a predetermined duration, the feedback index indicating one beam pattern respectively selected by the at least one receiver station among the beam patterns.

It is to be understood that both the foregoing general description and the following detailed description are exemplary and explanatory and are intended to provide further explanation of the invention as claimed.

### Advantageous Effects

According to the embodiments of the present invention, the period of beam search and tracking may be adaptively controlled, taking into consideration antenna angles of transmitting and receiving ends and receiver information, and a beam pattern feedback is processed using a simple code, so that it is possible to minimize the amount of information and hardware required for beam search and tracking. Times or channels for beam tracking are allocated to stations that are going to create a beam link. Accordingly, in uni-directional beam tracking, it is possible to perform tracking on a number of beam links at once. In addition, in bi-directional beam tracking, a sub-channel is allocated to each station to allow a number of stations to simultaneously emit beam patterns, thereby reducing the amount of used channel time.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 illustrates a hierarchical structure according to the present invention.

FIG. 2 illustrates the case where mobility is not supported when the beam angle is small.

FIG. 3 illustrates the case where mobility is supported when the beam angle is large.

FIG. 4 illustrates a procedure for controlling beam angle and transmission power according to an embodiment of the present invention.

FIG. 5 illustrates a procedure for controlling the period of beam search and tracking according to another embodiment of the present invention.

FIG. 6 illustrates an example of a local area network to which the present invention is applied.

FIG. 7 illustrates an example of a general schedule for exchange of uni-directional tracking signals.

FIG. 8 illustrates an example beam pattern index applied to the present invention.

FIG. 9 illustrates an example schedule for exchange of uni-directional tracking signals according to an embodiment of the present invention.

FIG. 10 illustrates an example of a general schedule for exchange of bi-directional tracking signals.

FIG. 11 illustrates an example schedule for exchange of bi-directional tracking signals according to another embodiment of the present invention.

FIG. 12 illustrates an example frequency band in which each station emits a beam pattern in the example of FIG. 11.

FIG. 13 is a signal flow diagram illustrating a method for performing beam tracking taking into consideration channel time allocation according to an embodiment of the present invention.

FIG. 14 illustrates an example message used in the channel time request process of FIG. 13.

FIG. 15 illustrates an example message used in the channel time allocation process of FIG. 13.

FIG. 16 illustrates an example procedure in which a receiver station transmits a feedback index in FIG. 9.

FIG. 17 illustrates example beam patterns emitted by the transmitter station in FIG. 9.

FIG. 18 illustrates an example procedure in which the receiver stations transmit feedback indices to the transmitter station in FIG. 17.

FIG. 19 illustrates allocation of times for beam tracking in FIG. 9.

FIG. 20 illustrates example beam patterns that stations emit according to a schedule for exchange of bi-directional tracking signals according to another embodiment of the present invention.

FIG. 21 illustrates an example procedure in which stations exchange feedback indices in FIG. 20.

FIG. 22 illustrates allocation of times for beam tracking in FIG. 20.

FIG. 23 illustrates an example channel time that the coordinator allocates in FIG. 13.

FIG. 24 illustrates another example channel time that the coordinator allocates in FIG. 13.

FIG. 25 illustrates a configuration of a station according to an embodiment of the present invention.

### BEST MODE FOR CARRYING OUT THE INVENTION

Preferred embodiments of the present invention will now be described with reference to the accompanying drawings. However, the embodiments of the present invention described below can be modified into various other forms and the scope of the present invention is not limited to the embodiments.

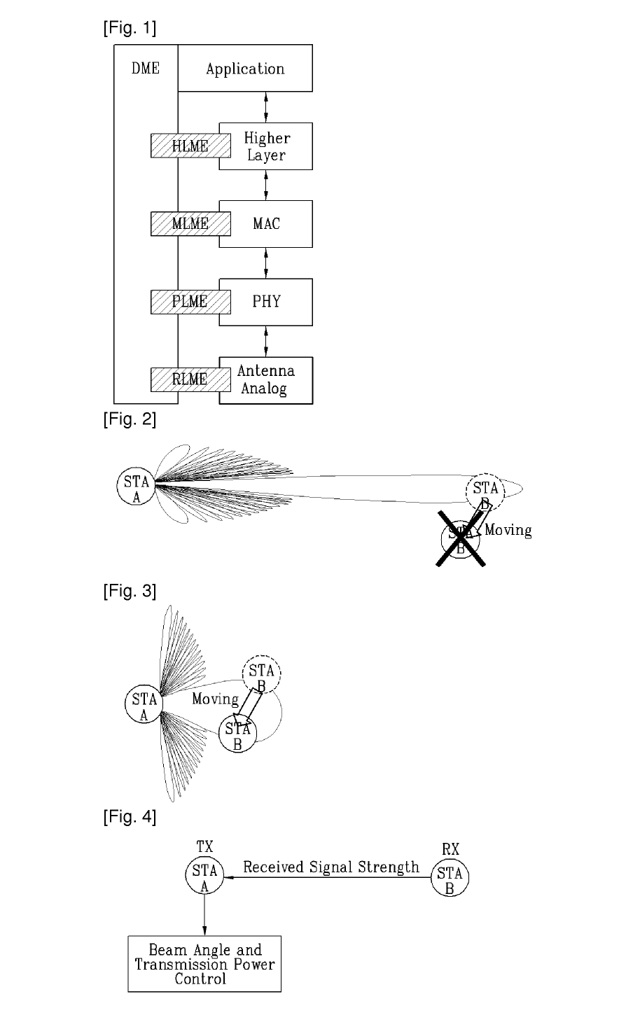

FIG. 1 illustrates a hierarchical structure according to the present invention.

The hierarchical structure includes an application layer, a higher layer, a MAC layer, and a PHY layer. The application layer is connected to a Device Management Element (DME), the higher layer is connected to the DME through a Higher Layer Management Element (HLME), the MAC layer is connected to the DME through a MAC Layer Management Element (MLME), and the PHY layer is connected to the DME through a PHY Layer Management Element (PLME).

In the case of wireless communication having high directionality such as mmWave, there is also a need to consider an RF/analog front end as one layer to achieve harmonious management. In the hierarchical structure, an antenna analog layer, which is added as a layer for the RF/analog front end, is connected to the DME through a Radio Layer Management Element (RLME).

FIG. 2 illustrates the case where mobility is not supported when the beam angle is small.

It is not possible to support mobility unless beam search and tracking is frequently performed in the case where the beam angle is small as shown in FIG. 2.

On the other hand, it is easy to support mobility if the beam angle is large. Although the beam range may decrease as the beam angle increases, the short beam range may be compensated for by controlling transmission power.

FIG. 3 illustrates the case where mobility is supported when the beam angle is large.

In the case of FIG. 3, the angle of beam transmission from a station A is larger than that of the case of FIG. 2. In this case, the probability that a station B will exit the beam while in motion is smaller than that of the case of FIG. 2 in proportion to how much larger the beam angle is than that of FIG. 2.

FIG. 4 illustrates a procedure for controlling beam angle and transmission power according to an embodiment of the present invention.

It is possible to create an optimal beam for each case by controlling beam angle and transmission power according to the distance between stations or received signal strength. In FIG. 4, if the received signal strength is higher than necessary, it is possible to increase the antenna angle instead of reducing transmission power. This reduces the probability that a station will exit the beam while in motion.

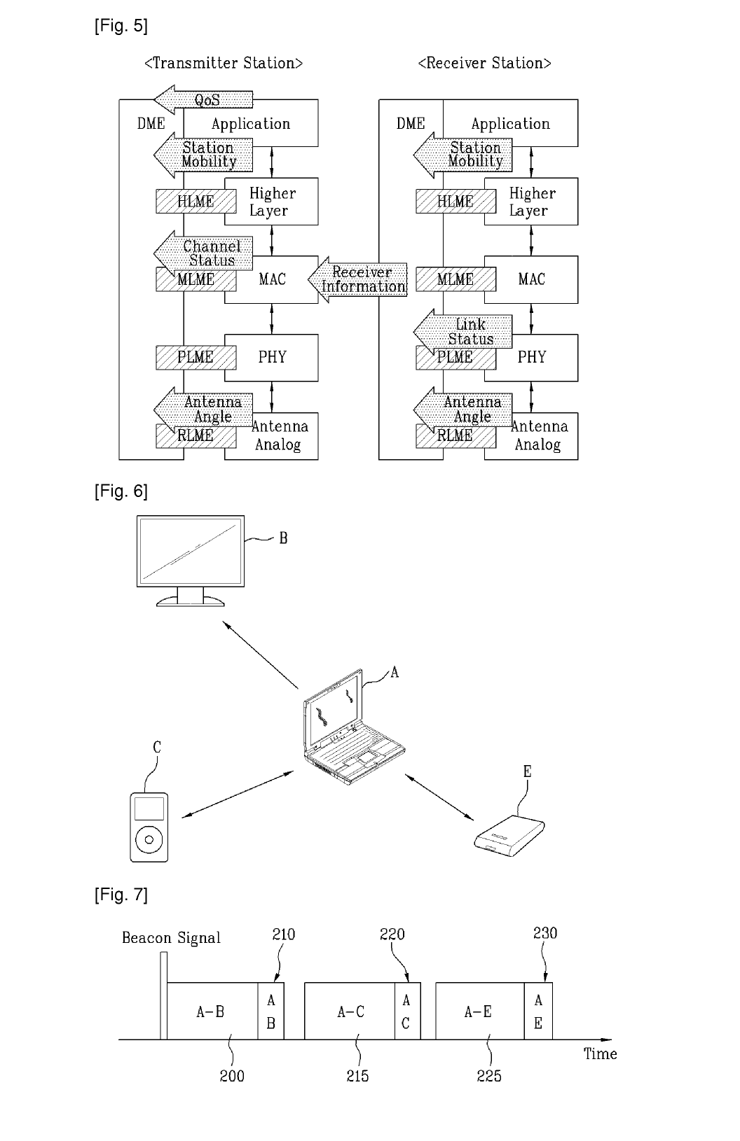

FIG. 5 illustrates a procedure for controlling the period of beam search and tracking according to another embodiment of the present invention.

The period of beam search and tracking is time interval between current beam tracking process and next beam tracking process. The period of beam search and tracking may be determined according to parameters of Table 1.

Specifically, the period of beam search and tracking can be changed periodically taking into consideration the beam angle of the transmitter station or the receiver station, the quality of service of the application layer (Application QoS), Station mobility, and channel time status.

TABLE 1

| | | | | | Beam |
|---|---|---|---|---|---|
| Beam | Application | Station | Channel | | Tracking |
| Angle | QoS | Mobility | Time Status | Point | Period |
| Large | High | High | Busy | 8 | Often |
| Large | High | High | Idle | 16 | Very Often |
| Large | High | Low | Busy | 4 | Regular |
| Large | High | Low | Idle | 8 | Often |
| Large | Low | High | Busy | 4 | Regular |
| Large | Low | High | Idle | 8 | Often |
| Large | Low | Low | Busy | 2 | Seldom |
| Large | Low | Low | Idle | 4 | Regular |
| Small | High | High | Busy | 4 | Often |
| Small | High | High | Idle | 8 | Very often |
| Small | High | Low | Busy | 2 | Seldom |
| Small | High | Low | Idle | 4 | Often |
| Small | Low | High | Busy | 2 | Seldom |
| Small | Low | High | Idle | 4 | Often |
| Small | Low | Low | Busy | 1 | Very |
| | | | | | Seldom |
| Small | Low | Low | Idle | 2 | Seldom |

For example, each parameter may be information indicating whether the level of the parameter is greater or smaller than a predetermined level as shown in Table 1.

Beam tracking may be performed at intervals of a long period if the beam angle is large, if the sensitivity of QoS is low, or if the channel time is sufficient. A larger number of beam tracking efforts are needed if the station mobility is high. Accordingly, it is preferable that the Device Management Element (DME) determine the period of beam search and tracking taking into consideration at least one of the above parameters.

In addition, it is possible to determine the best period if stations that established a beam link exchange the receiver information as status information in addition to the parameters of Table 1. In the example of FIG. 5, the receiver information as status information includes the receiver station mobility information of the application layer, the link status information of the physical layer, and the antenna angle information of the antenna analog layer. The receiver information may be transmitted periodically to the transmitter station and accordingly the period of beam search and tracking may also be changed periodically.

The period of beam search and tracking may be determined by the transmitter station or the receiver station. In one example, the DME of the transmitter station may determine how often beam tracking will be performed using the beam angle, the QoS information of the application layer, the station mobility information, and the channel time status information of the transmitter station and the mobility information, the antenna angle information, and the link status information of the receiver station.

For example, while it will be more advantageous to perform tracking as often as possible if the channel time is sufficient, beam search and tracking may be performed as often as possible for a beam link having a higher QoS if the channel time is not sufficient.

Each station may determine the period of beam search and tracking and may then request a channel time or a channel allocating information including the determined period to a coordinator. In this case, it is possible to perform a best beam tracking process without interference of the coordinator.

FIG. 6 illustrates an example of a local area network to which the present invention is applied.

As shown in FIG. 6, a notebook A, a monitor B, a PMP C, an external hard disk drive E, and the like can be connected wirelessly. Here, a beam link may be created between the notebook A and the monitor B, between the notebook A and the PMP C, and between the notebook A and the external hard disk drive E.

FIG. 7 illustrates an example of a general schedule for exchange of uni-directional tracking signals.

Generally, the transmitter station A performs beam tracking on each of the receiver stations B, C, and E. Specifically, beam tracking between the transmitter station A and the receiver station B is performed, independently of the remaining receiver stations C and E, in a predetermined time 210 after data transmission 200 is completed. Beam tracking between the transmitter station A and the receiver station C is also performed, independently of the remaining receiver stations B and E, in a predetermined time 220 after data transmission 215 is completed. Similarly, beam tracking between the transmitter station A and the receiver station E is also performed, independently of the remaining receiver stations B and C, in a predetermined time 230 after data transmission 225 is completed. If the number of beam links in the network is too large, this method is not efficient since the time required to perform beam search and tracking may be too long.

To create a beam link, each station needs to transmit feedback for a received beam pattern. A method of exchanging or feeding back antenna weight vector requires a long time since the amount of data is great.

In the present invention, a beam pattern index can be used to reduce the amount of data. Particularly, the beam pattern index may be transmitted in a preamble format instead of being transmitted through a physical layer for data transmission. A barker code may be used as the beam pattern index.

The barker code of 13 bits has a narrow band of 38.4 kHz and has very excellent auto-correlation characteristics and also high accuracy and resolution.

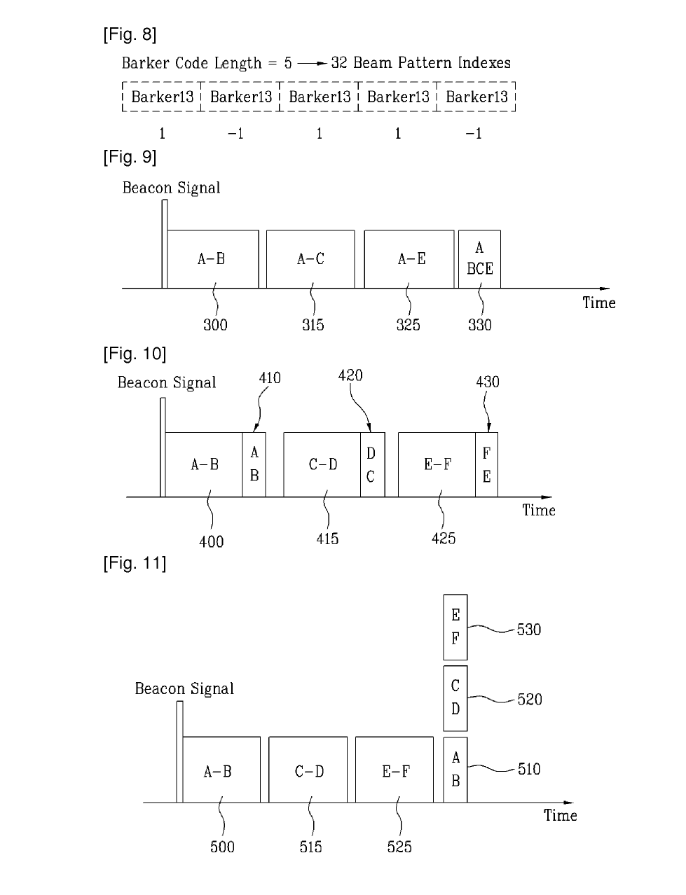

FIG. 8 illustrates an example beam pattern index applied to the present invention.

In the example of FIG. 8, 32 beams are represented using a simple barker code of length 5. This makes it possible to identify the beam pattern index, even using a simple correlator. Accordingly, stations that are going to create a beam link can easily exchange a pattern index.

FIG. 9 illustrates an example schedule for exchange of uni-directional tracking signals according to an embodiment of the present invention.

In many cases where a wireless solution is used for PC peripherals, a number of stations around a PC can simultaneously communicate via the PC. In this case, it is inefficient to perform beam tracking on each individual link.

As shown in FIG. 9, a transmitter station A may emit a beam pattern once and receiver stations may then provide feedback in a predetermined time 330. When the transmitter station A emits a beam pattern for beam tracking after data transmission 300, 315, and 325 is completed, peripheral devices B, C, and E participate in a beam tracking procedure at once. This method makes it possible to receive as much feedback as possible through one search.

To accomplish this, it is necessary to allocate a beacon signal to which a time interval for search and tracking or the like is allocated. In addition, relevant stations need to be prepared to feed a beam pattern index back in a time allocated to the beacon signal.

FIG. 10 illustrates an example of a general schedule for exchange of bi-directional tracking signals.

Beam tracking between a station A and a station B is performed, independently of the remaining stations C, D, E, and F, in a predetermined time 410 after data transmission 400 is completed. Beam tracking between the station A and the station D is also performed, independently of the remaining stations A, B, E, and F, in a predetermined time 420 after data transmission 415 is completed. Similarly, beam tracking between the station E and the station F is also performed, independently of the remaining stations A, B, C, and D, in a predetermined time 430 after data transmission 425 is completed. If the number of beam links in the network is too large, this method is not efficient since the time required to perform beam search and tracking may be too long.

FIG. 11 illustrates an example schedule for exchange of bi-directional tracking signals according to another embodiment of the present invention.

If a sub-channel for beam search is defined for each station, it is possible to simultaneously perform beam search and beam tracking of a number of links. This can save channel time.

As shown in FIG. 11, after data transmission 500, 515, and 525 is completed, stations can simultaneously perform beam tracking using respective sub-channels allocated to the stations in predetermined times 510, 520, and 530. In the case where the channel time is not sufficient for a specific station to emit all beam patterns, the station may separately emit beam patterns instead of emitting the beam patterns at once.

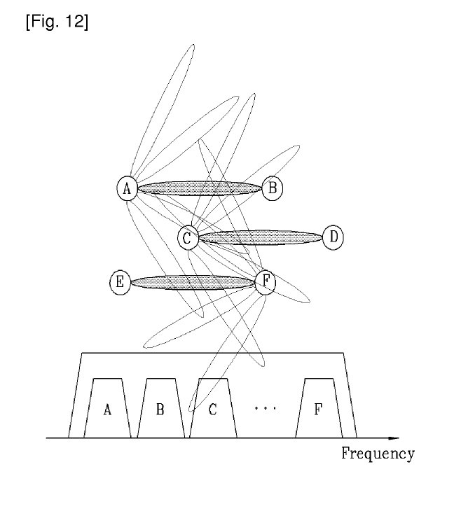

FIG. 12 illustrates an example frequency band in which each station emits a beam pattern in the example of FIG. 11.

As shown in FIG. 12, stations A, B, C, D, E, and F can simultaneously emit beam patterns. This causes no interference since the frequency bands A, B, C, . . . , F of sub-channels allocated to the stations are different from each other. To accomplish this, it is necessary for the coordinator to allocate a channel time for beam tracking and search to each station so that the station can use the channel time when performing beam tracking and search.

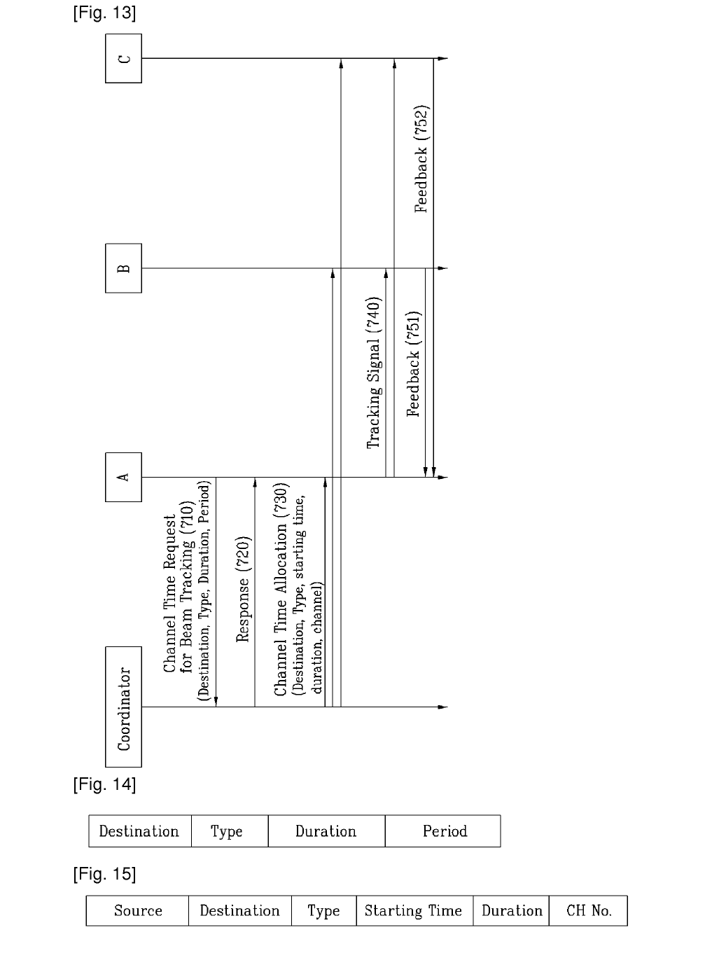

FIG. 13 is a signal flow diagram illustrating a method for performing beam tracking taking into consideration channel time allocation according to an embodiment of the present invention.

First, a station A transmits a request message requesting a channel time for beam tracking to a coordinator (710). In the example of FIG. 13, the coordinator is provided as a station independent of stations A, B, and C. In the case of uni-directional tracking, the coordinator may be added in a software or hardware form to a transmitter station.

Then, the coordinator transmits a response or channel allocating information to the request message to the station A (720). This process may be omitted.

In response to the request message, the coordinator allocates a starting time, a tracking duration, or the like of beam tracking to the station A. In the case where each station uses a different sub-channel, the coordinator can allocate a different channel number to each station. The coordinator transmits the allocation result through channel allocating information or allocation information (730). Here, the allocation information or the channel allocating information may be broadcast through a beacon signal.

When the station A has received the channel allocating information from the coordinator, the station A emits beam patterns including respective beam pattern indices toward the stations B and C based on the channel allocating information (740).

The stations B and C may also receive channel allocating information from the coordinator. Upon receiving the beam patterns, each of the stations B and C feeds a beam pattern index with the greatest signal strength among the received beam patterns back to the station A (751 and 752). In the case where the stations B and C have received channel allocating information, each of the stations B and C may feed the feedback index back to the station A at a channel time indicated by the channel allocating information.

On the other hand, in the case of bi-directional tracking, each of the stations B and C can transmit the feedback index while emitting its own beam patterns.

FIG. 14 illustrates an example message used in the channel time request process 710 of FIG. 13.

For smooth beam search and tracking, one of a plurality of stations in a network may request a beam search and tracking channel time to the coordinator. Not only the station that has made the request but also related stations may operate according to the allocated channel time. The station that requests the beam search and tracking channel time to the coordinator may be a station that has relatively low mobility or a stationary station.

A request message used to request such beam search and tracking includes the following information.

Destination information indicates a station identifier (STA ID) of a target station and type information indicates the purpose of allocation, i.e., indicates beam tracking and search. Preferably, the type information may indicate whether the beam tracking is unidirectional or bi-directional

Duration information indicates a time or duration required for beam tracking or search and period information indicates how often beam tracking is to be performed.

FIG. 15 illustrates an example message used in the channel time allocation process 730 of FIG. 13.

The message or channel allocating information includes the following information. Source information indicates a station identifier (STA ID) of a station that emits beam patterns. Destination information indicates a station identifier (STA ID) of a target station. Using the source information and the destination information, each station can determine which station has emitted a beam pattern and to which station it should send feedback.

Type information indicates the purpose of allocation, i.e., indicates beam tracking and search. Preferably, the type information may indicate whether the beam tracking is uni-directional or bi-directional.

Duration information indicates a time or duration that the coordinator has allocated for beam tracking or search and period information indicates a tracking period determined by the coordinator.

Channel number (CH No.) information is sub-channel information regarding a sub-channel that the coordinator allocates to each station when beam search or tracking is separately performed for each sub-channel. If each station is allocated a different sub-channel, no interference may occur even when each station performs search at the same time.

The coordinator may broadcast the information through a beacon signal.

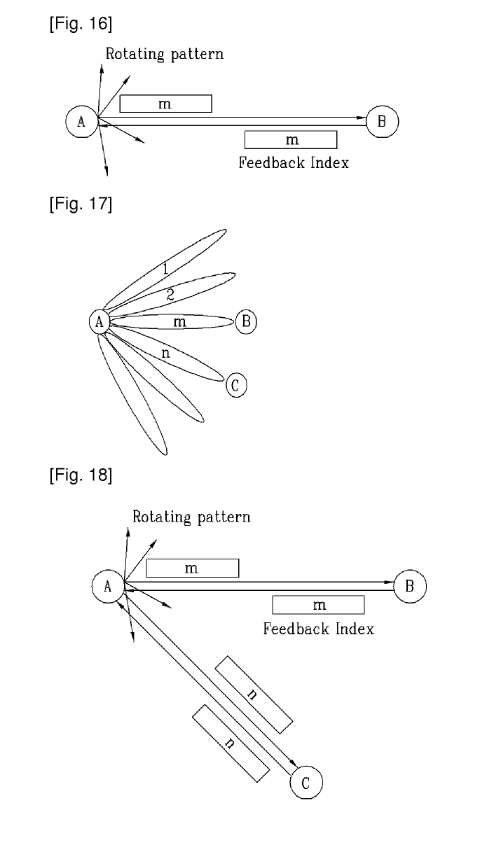

FIG. 16 illustrates an example procedure in which a receiver station transmits a feedback index in FIG. 9.

The station A is allocated a channel time for beam tracking by the coordinator and transmits beam patterns including beam pattern indices during the channel time. The station B listens to or receives the beam patterns and determines a best beam pattern with the highest signal quality from among the listened or received beam patterns. In FIG. 16, the station B determines ‘m’ as the best beam pattern. When the station B has transmitted an index ‘m’ to the station A, a beam link is created between the station A and the station B.

FIG. 17 illustrates example beam patterns emitted by the transmitter station in FIG. 9.

When the transmitter station emits beam patterns in a number of directions, the transmitter station incorporates a different beam pattern index into the beam patterns of each direction. Each receiver station can determine a beam pattern with the highest signal strength from among the beam patterns and feed a corresponding beam pattern index back to the transmitter station.

FIG. 18 illustrates an example procedure in which the receiver stations transmit feedback indices to the transmitter station in FIG. 17.

The station A is allocated a channel time for beam tracking by the coordinator and transmits beam patterns including beam pattern indices. Then, each of the stations B and C listens to the beam patterns and determines a best beam pattern with the highest signal quality. In FIG. 18, the station B determines ‘m’ as the best beam pattern and the station C determines ‘n’ as the best beam pattern.

Each of the stations B and C feeds a beam pattern index indicating the best beam pattern in a channel time allocated for feedback back to the station A. Here, channel access may be performed using a Listen-Before-Talk (LBT) method or using a method in which a time allocated for feedback is used for each station.

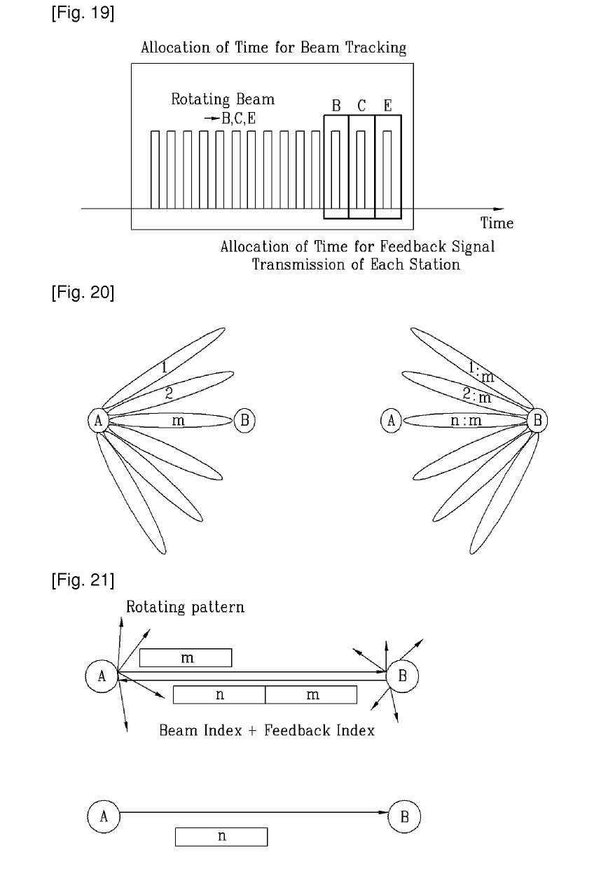

FIG. 19 illustrates allocation of channel times for beam tracking in FIG. 9.

In FIG. 19, the time axis represents beam patterns that are sequentially emitted by the station A. Each of the receiver stations B, C, and E transmits, to the station A, a feedback index in a channel time allocated to the receiver station for feedback signal transmission.

FIG. 20 illustrates example beam patterns that stations emit according to a schedule for exchange of bi-directional beam tracking signals according to another embodiment of the present invention.

In the case where bi-directional beam tracking is needed after a station A emits beam patterns, a station B may emit its beam patterns for feedback index transmission. That is, when performing feedback, each station may emit rotating beam patterns for feedback in all directions instead of transmitting beam patterns in a specific direction.

FIG. 21 illustrates an example procedure in which stations exchange feedback indices in FIG. 20.

First, let us assume that a station A has emitted beam patterns including a beam pattern index ‘m’ of the station A. When a station B emits beam patterns including a beam pattern index ‘n’ of the station B and a feedback index ‘m’, the station A determines a best beam pattern from among the beam patterns emitted by the station B. When the station A emits a feedback index ‘n’ indicating the best beam pattern to the station B, a beam link is created between the station A and the station B.

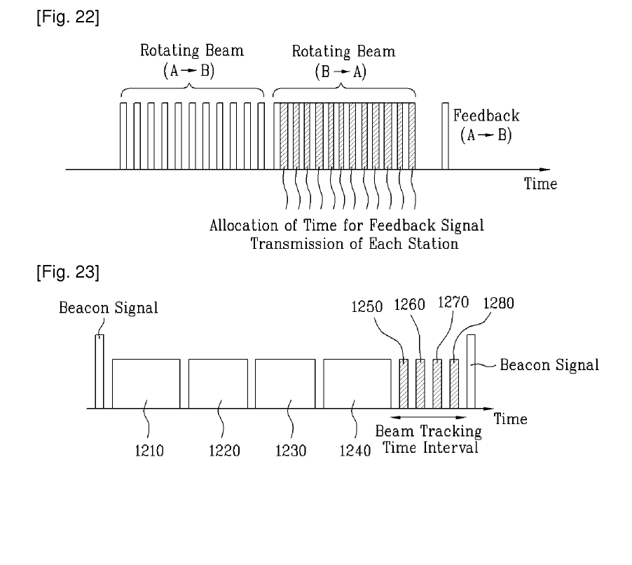

FIG. 22 illustrates allocation of times for beam tracking in FIG. 20.

Specifically, FIG. 22 shows channel times that a station B is allocated for transmitting a beam pattern index of the station B and a feedback index in all directions. When a bi-directional link is needed as in this case, each station may emit beam patterns to transmit a feedback index in all directions. In the case where a station transmits a feedback index, the station A may simply transmit a feedback index to the station B without the need to emit beam patterns.

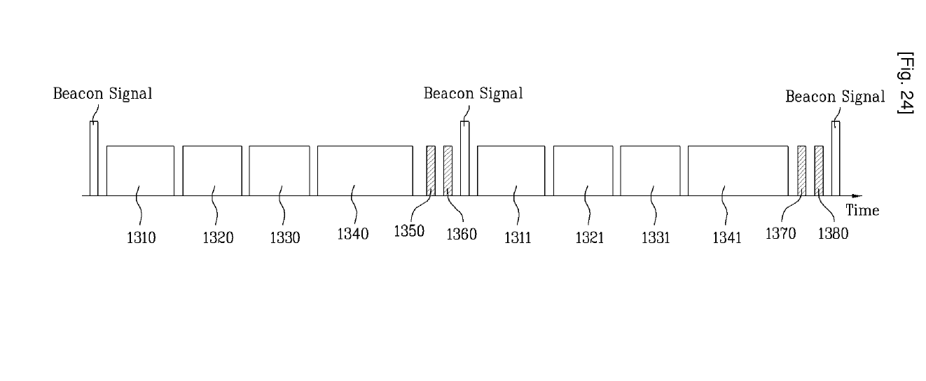

FIG. 23 illustrates an example channel time that the coordinator allocates in FIG. 13.

A beacon signal includes information regarding a channel time allocated by the coordinator. If allocation information or channel allocating information of the beacon signal is changed, operations associated with tracking of stations are also changed. The allocation information can be applied in each beacon interval.

Channel Time or time duration for beam tracking can be allocated in a variety of formats by the coordinator and can also be allocated after data transmission (1210, 1220, 1230, and 1240) between stations is completed as shown in FIG. 20.

Channel Time or time duration 1250, 1260, 1270, and 1280 in the beam tracking channel time or time duration are allocated respectively for stations that emit beam patterns and each of the channel time or time duration is used for beam pattern emission and associated feedback transmission of the corresponding station. Although an individual channel time or time duration is required for each station which emits beam patterns, a number of stations may simultaneously operate in one channel time or time duration (for example, the first time duration 1250) in the case where each station operates with a different sub-channel as described above.

FIG. 24 illustrates another example channel time that the coordinator allocates in FIG. 13.

When it is determined that the channel time is insufficient for a channel time request, the coordinator may accommodate the channel time request in a distributed manner over a number of beacon intervals. The beacon interval may be defined as an interval between a timing point of transmitting a beacon signal and a timing point of transmitting a next beacon signal. And, the beacon interval may mean an interval between a beacon period and a next beacon period.

For example, one half (1350 and 1360) of a total required beam tracking channel time or time duration may be allocated to a first beacon interval and the other half (1370 and 1380) thereof may be allocated to a second beacon interval as shown in FIG. 24.

Channel Time or time duration for beam tracking may be allocated in a variety of formats by the coordinator and may also be allocated after data transmission (1310, 1311, 1320, 1321, 1330, 1331, 1340, and 1341) between stations is completed as shown in FIG. 24.

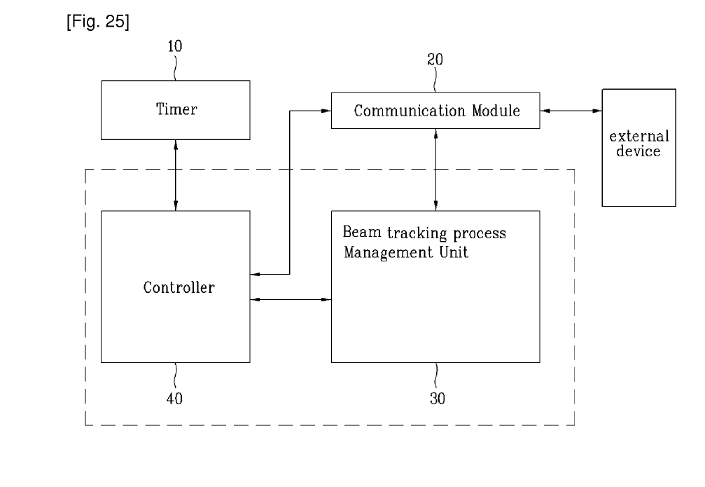

FIG. 25 illustrates a configuration of a station according to an embodiment of the present invention.

As shown in FIG. 25, a station according to the present invention may include a timer 10, a communication module 20, a beam tracking process management unit 30, and a controller 40.

The timer 10 serves to indicate the start and end of a beacon interval which is the interval between a beacon signal and a next beacon signal. The timer 10 can also provide time information in the beacon interval. For example, the timer 10 can provide the time point of a channel time allocated by the coordinator. The communication module 20 can serve to transmit data or signals to another station or the coordinator or to receive data or signals transmitted from another station or the coordinator. For example, under control of the controller 40, the communication module 20 serves to receive receiver status information from a receiver station, to transmit a request message requesting channel time allocation for beam tracking to the coordinator, or to transmit or receive a beam pattern to or from another station.

The beam tracking process management unit 30 can determine a beam tracking period based on at least one of status information of a transmitter station and status information of a receiver station received through the communication module 20. The beam tracking process management unit 30 can also determine a message requesting a channel time for beam tracking. For example, when requesting a channel time for beam tracking, the beam tracking process management unit 30 can determine an identifier of a target station, the direction of beam tracking, the duration of the channel time, and the period of beam tracking. When the beam tracking process management unit 30 has received channel time allocation information regarding the requested channel time from the coordinator through the communication module 20, the beam tracking process management unit 30 can determine information of a channel time for beam tracking. Here, the received channel time allocation information can include sub-channel information so that a plurality of sub-channels with different frequency bands can be set in the same channel time to enable stations to simultaneously perform beam tracking. It is also possible to set a beam pattern index for each beam pattern for beam tracking. It is also possible to determine a best beam pattern from among beam patterns received from another station.

The controller 40 can perform a control operation so as to perform beam tracking according to the period of beam tracking determined by the beam tracking process management unit 30. The controller 40 can also perform a control operation so as to transmit a message requesting a channel time for beam tracking determined by the beam tracking process management unit 30 to the coordinator through the communication module 20. The controller 40 can also perform a control operation so as to perform beam tracking according to the channel time for beam tracking using the channel time information determined by the beam tracking process management unit 30. The controller 40 can also perform a control operation so as to transmit beam patterns identified by the beam pattern indices set by the beam tracking process management unit 30 through the communication module 20. The controller 40 can also perform a control operation so as to transmit beam pattern index information, indicating the best beam pattern determined by the beam tracking process management unit 30, to a corresponding station.

Although the functions of the controller 40 and the beam tracking process management unit 30 are illustrated as being separate in this embodiment, it will be apparent that the functions of the controller 40 may include those of the beam tracking process management unit 30.

### MODE FOR THE INVENTION

Various embodiments have been described in the best mode for carrying out the invention. Although the present invention has been described with reference to the embodiments illustrated in the drawings, the embodiments are only illustrative and it will be apparent to those skilled in the art that various modifications and variations can be made from the embodiments. Such modifications and variations should be construed as being included in the scope of the invention. Thus, the scope of the invention should be determined based on the spirit of the appended claims.

### INDUSTRIAL APPLICABILITY

The present invention provides a method for achieving efficient beam search and tracking when performing wireless transmission having high directionality and thus can be applied to wireless stations that are included in a communication network having high directionality such as mmWave.

1. An apparatus for controlling beam tracking process, the apparatus comprising:
a communication module configured to transmit data to at least one of external station and coordinator, and configured to receive data from at least one of external station and coordinator; and
a controller configured to control the communication module to transmit first beam patterns to at least one station, each of the first beam patterns being identified by beam pattern index, and configured to control the communication module to receive a feedback index from the at least one station during a predetermined duration, the feedback index indicating one beam pattern selected by the at least one station among the first beam patterns.

2. The apparatus of claim 1, wherein the first status information includes mobility information, link status information and antenna angle information about the receiver station.

3. The apparatus of claim 1, wherein the second status information includes quality of service (QoS) information, mobility information, channel status information and antenna angle information about the transmitter station.

4. An apparatus for performing beam tracking process, the apparatus comprising:
a communication module configured to transmit data to at least one of external station and coordinator, and configured to receive data from at least one of external station and coordinator; and
a controller configured to control the communication module to transmit a request message requesting to allocate a channel time for performing the beam tracking process, configured to control the communication module to receive channel allocating information corresponding to the request message, and configured to control to perform the beam tracking process using a beam pattern index based on the channel allocating information.

5. The apparatus of claim 4, wherein the channel allocating information includes starting information, duration information and channel number information, and wherein the starting information indicates starting point of an allocated channel time, and the duration information indicates duration of the allocated channel time, and the channel number information indicates identification identifying sub-channels, the sub-channels being divided by a frequency band during the allocated channel time.

6. An apparatus for controlling beam tracking process, the apparatus comprising:
a communication module configured to transmit data to at least one of external station and coordinator, and configured to receive data from at least one of external station and coordinator; and
a controller configured to control the communication module to transmit first beam patterns to at least one station, each of the first beam patterns being identified by beam pattern index, and configured to control the communication module to receive a feedback index from the at least one station during a predetermined duration, the feedback index indicating one beam pattern selected by the at least one station among the first beam patterns.

7. The apparatus of claim 6, wherein the beam pattern index and the feedback index are generated by using a baker code.

8. The apparatus of claim 6, wherein the predetermined duration includes a plurality of sub channels, the sub channels being divided by a different frequency band at same time, and the feedback index of the at least one station is received via the sub channel.

9. A method for performing a beam tracking process in a transmitter station, the method comprising:
receiving first status information from a receiver station, the first status information being associated with status of the receiver station;
determining a period of the beam tracking process based on second status information and the first status information, the second status information being associated with status of the transmitter station; and
performing the beam tracking process every the determined period, wherein the period is time interval between current beam tracking process and next beam tracking process.

10. The method of claim 9, wherein the first status information is received periodically.

11. The method of claim 9, wherein the first status information includes mobility information, link status information and antenna angle information about the receiver station.

12. The method of claim 11, wherein the second status information includes quality of service (QoS) information, mobility information, channel status information and antenna angle information about the transmitter station.

13. The method of claim 12, wherein the determining step further comprising:
if the antenna angle information included in the first and second status information indicates that an antenna angle of at least one of the transmitter station and the receiver station is larger than a predetermined value, the period of the Beam Tracking process is controlled to decrease.

14. The method of claim 12, wherein the determining step further comprising:
if the QoS information included in the second status information indicates that a quality of service (QoS) of the transmitter station is higher than a predetermined level, the period of the beam tracking process is controlled to decrease.

15. The method of claim 12, wherein the determining step further comprising:
if the mobility information included in the first and second status information indicates that a mobility of at least one of the transmitter station and the receiver station is higher than a predetermined status, the period of the beam tracking process is controlled to decrease.

16. The method of claim 12, wherein the determining step further comprising:
if the channel status information in the second status information indicates idle status of the transmitter station, the period of the beam tracking process is controlled to decrease.

17. The method of claim 12, wherein the antenna angle information included in the first and second status information is determined from a radio layer management element (RLME) being connected to an antenna analog layer.

18. A method for performing beam tracking process in a station, the method comprising:
transmitting a request message requesting to allocate a channel time for performing the beam tracking process to a coordinator;
receiving channel allocating information corresponding to the request message from the coordinator; and
performing the beam tracking process using a beam pattern index based on the channel allocating information.

19. The method of claim 18, wherein the channel allocating information includes starting information, duration information and channel number information, and wherein the starting information indicates starting point of an allocated channel time, and the duration information indicates duration of the allocated channel time, and the channel number information indicates identification identifying sub-channels, the sub-channels being divided by a frequency band during the allocated channel time.

20. The method of claim 18, wherein the request message includes at least one destination information, type information, duration information and period information, and
wherein the destination information indicates a target station for the beam tracking process, and type information indicates direction of the beam tracking process, and the duration information indicates duration for the beam tracking process, and the period information indicates a period of the beam tracking process.

21. The method of claim 18, wherein the channel allocating information further includes station identification information identifying stations participated in the beam tracking process.

22. A method for controlling beam tracking process, the method comprising:
transmitting first beam patterns to at least one station, each of the first beam patterns being identified by beam pattern index; and
receiving a feedback index from the at least one station during a predetermined duration, the feedback index indicating one beam pattern selected by the at least one station among the first beam patterns.

23. The method of claim 22, wherein the beam pattern index and the feedback index are generated by using a baker code.

24. The method of claim 22, wherein the predetermined duration is a channel time allocated by a coordinator, for performing the beam tracking process.

25. The method of claim 22, wherein the at least one feedback index is received using a Listen-Before-Talk method.

26. The method of claim 22, wherein the predetermined duration includes a plurality of sub channels, the sub channels being divided by a different frequency band at same time, and the feedback index of the at least one station is received via the sub channel.

27. A method for controlling beam tracking process, the method comprising:
transmitting first beam patterns to a target station, each of the first beam patterns being identified by beam pattern index;
receiving first feedback index and second beam patterns from the target station during a predetermined duration, the first feedback index indicating one beam pattern selected by the target station among the first beam patterns, each of the second beam patterns being identified by beam pattern index;
determining one beam pattern among the second beam patterns; and
transmitting second feedback index to the target station, the second feedback index indicating the one beam pattern determined by determining step.

28. A method for performing a beam tracking process in a transmitter station, the method comprising:
receiving first status information from a receiver station, the first status information being associated with status of the receiver station;
determining a period of the beam tracking process based on second status information and the first status information, the second status information being associated with status of the transmitter station;
transmitting a request message requesting to allocate a channel time for performing the beam tracking process to a coordinator according to the period of the beam tracking process;
receiving channel allocating information corresponding to the request message from the coordinator;
transmitting beam patterns to at least one receiver station according to the channel allocating information, each of the beam patterns being identified by beam pattern index; and
receiving at least one feedback index from the at least one receiver station during a predetermined duration, the feedback index indicating one beam pattern respectively selected by the at least one receiver station among the beam patterns.
